(19) United States
(12) Patent Application Publication
(10) Pub. No.: US 2005/0251998 A1
(43) Pub. Date: Nov. 17, 2005

(54) Method for cutting and sealing of disposable multilumen tubing

(75) Inventors: Yakov Bar-Or, Haifa (IL); Amram Aizenfeld, Kibbutz Ramot Menashe (IL); Golan Salman, Tirat Hacarmel (IL); Michael Voloshin, Haifa (IL); Omer Shazifi, Haifa (IL); Idan Moshe Buder, Gilon (IL)

Correspondence Address: BRUCE E. LILLING;LILLING & LILLING P.C., P.O. BOX 560, GOLDEN BRIDGE, NY, 10526, US

(73) Assignee: Sightline Technologies Ltd., Haifa (IL)

(21) Appl. No.: 11/121,693

(22) Filed: May 4, 2005

Related U.S. Application Data
(60) Provisional application No. 60/570,609, filed on May 13, 2004.

(51) Int. Cl. H01R 43/00

(52) U.S. Cl. 29/859; 600/101

(57) ABSTRACT

A method and device for cutting and sealing of disposable multilumen tubing is disclosed. The method comprises providing a first surface and an opposite second surface, placing a portion of the multilumen tubing between the first and the second surface and applying heat and pressure to at least one of the first and the second surface so as to plastically deform and cut the said portion of the multilumen tubing and to heat-seal the cut ends thereof. The device for cutting and sealing comprises a first jaw and juxtaposed therewith a second jaw, said first and said second jaw are provided with respective first and second surface. The device further comprises biasing member exerting pressure on at least one of the said first and the second surface and a source of energy suitable for heating of at least one of the said first and the second surface.

### FIELD OF THE INVENTION

The present invention relates generally to the field of endoscopy and specifically to endoscopic apparatus used for colonoscopic procedures during which a flexible tube is inserted into the rectum and colon for examination of the colon interior for abnormalities. More particularly, the present invention refers to a method and device for cutting and heat-sealing of disposable multilumen tubing, which is used specifically, but not exclusively, with an endoscopic apparatus, having a disposable sleeve covering the flexible tube and which upon inflation enables advancement of the endoscope within the colon.

### BACKGROUND OF THE INVENTION

There are known endoscopes employing inflatable flexible sleeves for propulsion endoscope within colon.

Voloshin (U.S. Pat. No. 6,485,409) discloses an endoscope, which comprises an endoscopic probe, a bending section for directing the probe within the colon (steering unit), an insertion tube and a flexible covering sleeve or a sheath, which is coupled proximally to the probe. The bending section of the endoscope is located behind the probe. The sleeve is attached to the endoscope in such a manner that its folded section is retained between a cap and an internal spindle, which are located between the insertion tube and the probe head. When inflated, the folded section unfolds over a flange of the internal spindle and an inner portion of the sleeve is pulled in a distal direction.

In PCT/IL03/00661 an endoscope is described which employs a flexible inflatable sleeve, which before inflation is retained within a dispenser. The dispenser employed in this endoscope has entry and exit ports defining a transit passage through which the endoscope may pass. The dispenser is adapted to capture the sleeve as the endoscope is retracted through the transit passage in a proximal direction. In another embodiment, the dispenser includes an external sleeve fixed to the dispenser and this external sleeve is adapted to be extended from the dispenser when the endoscope is retracted so that the external sleeve covers the flexible sleeve. By virtue of this provision any contamination on the flexible sleeve remains within the external sleeve and does not contact the endoscope or any other objects or areas outside the patient's body. After the endoscope has been removed entirely from the flexible sleeve, the dispenser together with the external sleeve is discarded.

It is mentioned in the above reference that the endoscope is provided with an internal sleeve, which is also known as a multilumen tubing, since it is usually fitted with appropriate passages or lumens as required for irrigation, suction and for passing endoscopic tools therethrough. During the endoscopic procedure the multilumen tubing is in flow communication with the body passage, which is under examination. The multilumen tubing fits over inside working channel (or so-called guiding channel) provided along the insertion tube.

After the endoscopic procedure is completed, the endoscope is retracted from the body passage and there is a possibility for contaminating the endoscope's guiding channel by liquid or debris, which enter into the multilumen tubing during the endoscopic procedure and could leak out through the proximal extremity of the multilumen tubing as it is pulled outside through the guiding channel.

It is mentioned in the above reference, that in order to prevent contamination either a tightly-fitting cup is placed over the proximal extremity of the multiluinen tubing in order to seal its interior off or the proximal extremity of the multilumen tubing is crimped or heat-sealed.

Unfortunately absolutely no details are provided as to how this crimping or hot sealing procedure should be carried out, nor is construction of a device suitable for this purpose disclosed.

### SUMMARY OF THE INVENTION

The object of the present invention is to provide a new and improved method and device for preventing the spread of contamination originating from the disposable multilumen tubing used with an endoscope.

For a better understanding of the present invention as well of its benefits and advantages, reference will now be made to the following description of its embodiments taken in combination with the accompanying drawings.

### BRIEF DESCRIPTION OF THE DRAWINGS

FIG. 1 depicts a general view of an endoscopic apparatus of the invention, preferably a colonoscopic apparatus and its main components

FIG. 2 is a general view of a disposable dispenser and multilumen tubing.

FIG. 3 is a general view, showing the distal end of the multilumen tubing inserted within the dispenser and its proximal end is ready for insertion within a guide channel of an insertion tube.

FIG. 4 is a general view, showing the proximal end of the multilumen tubing almost fully inserted within the insertion tube.

FIG. 5 is a general view, showing the disposable multilumen tubing outside the dispenser.

FIG. 6 is a general view, showing the proximal extremity of the multilumen tubing and a spacer fitting.

FIG. 7 is a general view, showing the connector means attached to the proximal extremity of the multilumen tubing protruding from the spacer fitting.

FIG. 8 is a general view, showing the operation handle of the endoscope connected to the control unit.

FIG. 9 illustrates schematically the method and device for cutting and heat-sealing.

FIG. 10 is a general view, showing the embodiment of the device for cutting and heat-sealing in operation.

FIG. 11 is a general view, showing the embodiment of the device for cutting and heat-sealing.

FIGS. 12-18 are general views, showing additional embodiments of the device for cutting and heat-sealing.

### DETAILED DESCRIPTION OF THE INVENTION

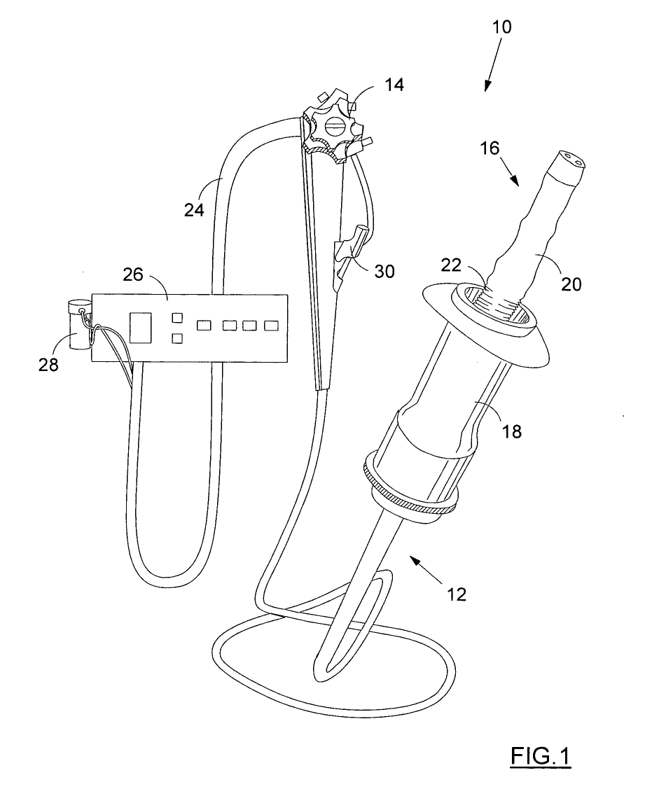

With reference to FIG. 1 an endoscopic apparatus, preferably a colonoscopic apparatus 10 is shown with its following main components. The apparatus comprises an endoscope having insertion tube 12 with its proximal section connected to an operation handle 14 and with its distal section 16 inserted in and protruding from a disposable dispenser 18.

It is seen also in FIG. 1 that a protective sleeve covers distal section 16 of the endoscope. That part of the sleeve, which is seen in FIG. 1, comprises a frontal non-inflatable portion 20 and a rear, folded portion 22. The frontal portion of the sleeve covers the distal section of the endoscope. The frontal portion does not inflate when the endoscope advances within the colon. The rear portion covers the insertion tube and unfolds when air or other fluid medium is supplied for inflating the sleeve. By virtue of this provision the feeding out sleeve propels the endoscope within the body passage. Explanation of this phenomenon can be found in the above referred to references. The endoscope of the present invention is of similar type in the sense that it employs the same propelling mechanism, which is based on inflation of a flexible protective sleeve coupled to the endoscope. It should be appreciated, however, that the present invention is not limited to the colonoscopic procedure and it can be employed in any other medical procedure requiring insertion of a probe in a body passage for inspection of its interior.

It is seen also in FIG. 1, that the handle is connected by appropriate umbilical duct 24 to a control unit 26 provided with a source of compressed air for inflating and venting the sleeve. Proximate to the control unit a flask 28 is provided, which is filled with water, to be supplied under pressure into the body passage for irrigation. Water and air are supplied to the handle through dedicated tubes (not shown) attachable to the umbilical duct.

One should bear also in mind that within the insertion tube are provided various devices, which are necessary for proper functioning of the endoscope. These devices are known per se. Among such devices one can mention vertebrae and strings, which can be manipulated by the handle, and a multilumen tubing with appropriate passages for supplying water, as required for irrigation or a vacuum required for suction. The multilumen tubing also is provided with a dedicated passage for introducing surgical instruments into the colon as might be required during the endoscopic procedure. Along the insertion tube might extend also a dedicated tube through which air is supplied as required for inflating the sleeve.

The multulumen tubing extends through the endoscope and through the handle to a connector means 30, which provides flow communication between lumens of the multilumen tubing and is attached to the umbilical duct tubes for supplying air and vacuum from the control unit and water from the flask.

In FIG. 2 is shown a general view of a disposable set for use with the endoscopic apparatus seen in FIG. 1. More detailed description of the set can be found in our patent application U.S. Ser. No. 60/570,608, whose disclosure is incorporated herein by reference. The set includes a disposable dispenser 18 and disposable multilumen tubing 32, having its distal section inserted within the dispenser and its proximal section extending outside the dispenser. An end 34 of the proximal section is adapted for airtight connection to the connector means 30.

It is not seen in FIG. 2 but should be appreciated that to the distal end of the multilumen tubing is attached a cap having a window fitted with transparent closure. Through this window illuminating light can propagate and thus viewing optics of a camera head may observe the interior of a body passage when the endoscope is inserted therein.

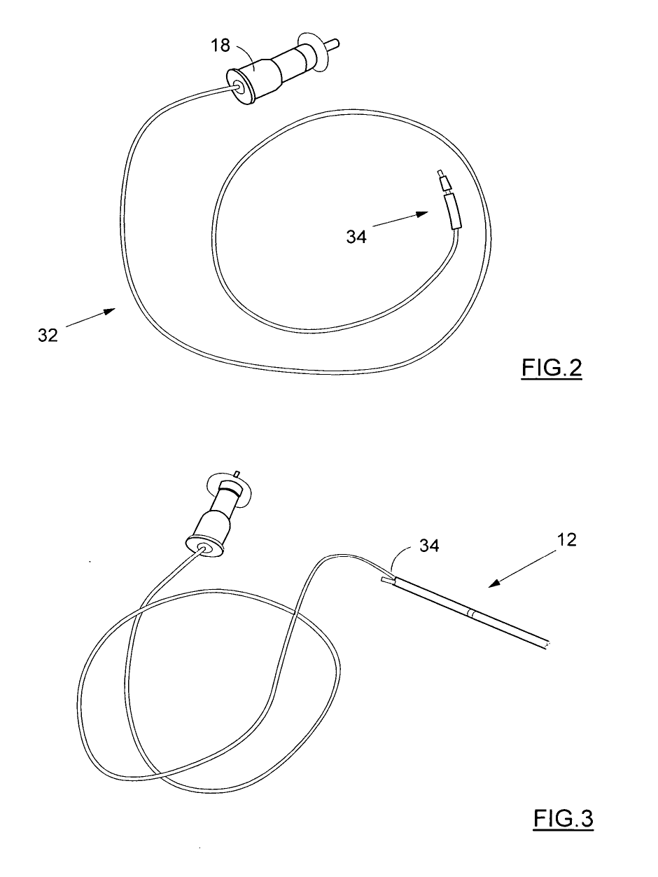

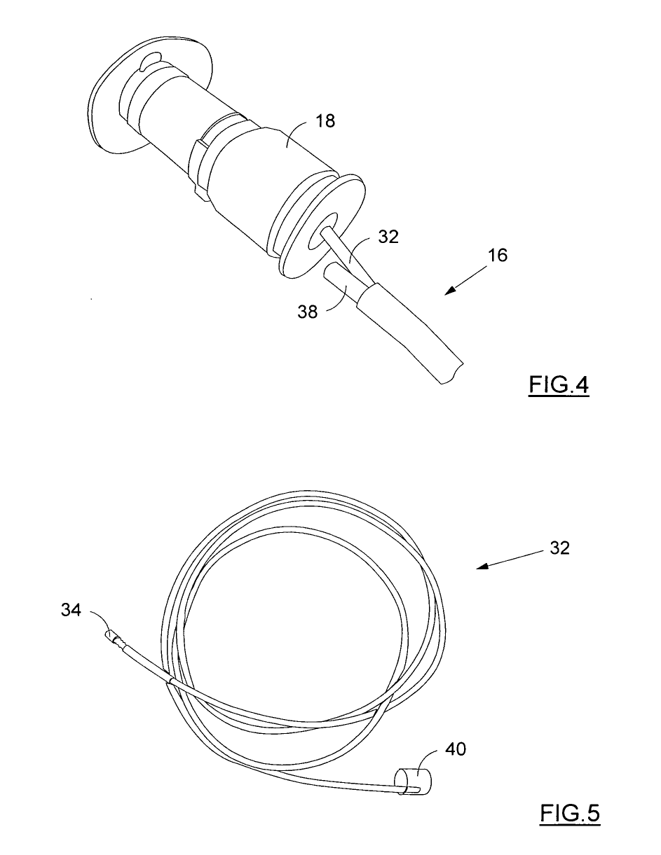

It should be also born in mind that in FIG. 2 the dispenser and the multilumen tubing are depicted during preparation for the endoscopic procedure. As shown in FIG. 3 and FIG. 4 during the preparation step the end 34 of the multilumen tubing is inserted within a guiding channel of the insertion tube 12. Then distal section 16 of the endoscope is displaced along an arrow seen in FIG. 4 and is inserted into the dispenser via an entry port 36. After that the distal section of the endoscope is advanced along the dispenser until it protrudes therefrom. It is seen in FIG. 4, that the distal section of the endoscope terminates by an optical head 38, which has saddle-like cross-sectional configuration enabling the multilumen tubing to pass therethrough and through the guiding channel (not shown)

In FIG. 5 the multilumen tubing is shown outside the dispenser but it should be born in mind that during the preparation procedure the multilumen tubing is retained within the dispenser, since it is a component of the disposable set.

It is also seen that to the distal section of the multilumen tubing is attached a cap 40. It is not shown specifically but should be appreciated that the cap has an access opening through which the interior of the body passage is accessible during the endoscopic procedure. The multilumen tubing is attached to the cap in such a manner that the access opening is in alignment with the passages of the multilumen tubing.

The dispenser, the multilumen tubing and the tubes passing along the umbilical duct are manufactured from plastic material; they are cheap, disposable items, which are discarded at the end of the endoscopic procedure after extracting the endoscope from the body passage. By virtue of this provision preparation of the endoscopic apparatus to the new endoscopic procedure is simple, convenient and fast. Furthermore, by virtue of the disposable set spreading of any contamination from within the body passage is prevented.

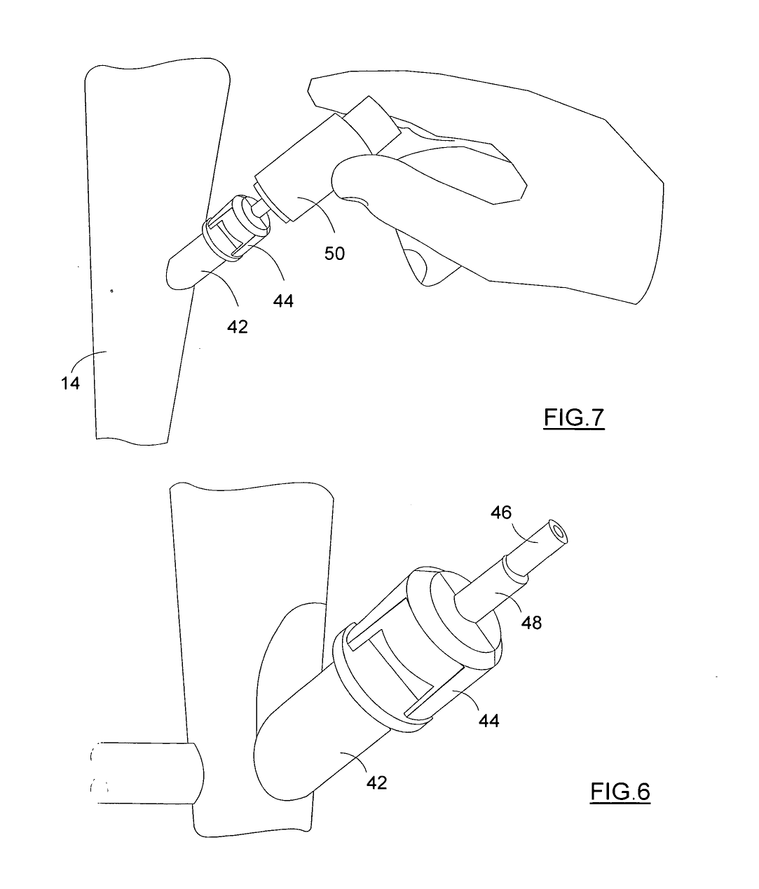

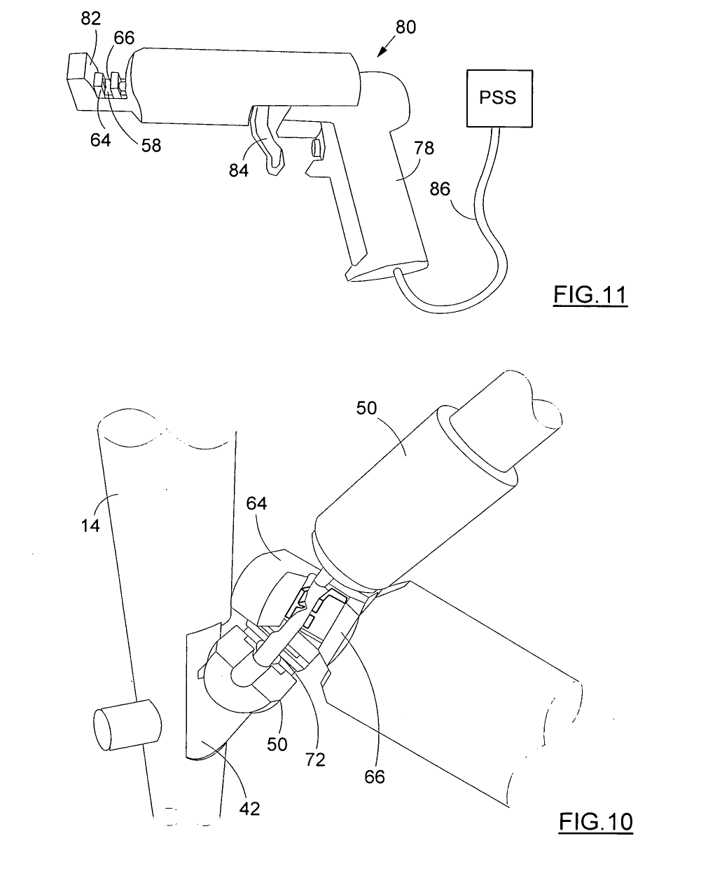

Referring now to FIG. 6 it is shown a situation when the multilumen tubing has been fully inserted in the insertion tube and its proximal extremity protrudes from a lateral port 40 of the handle 14. Attached to the lateral port is a spacer fitting 44, which consists of two halves closable on the multilumen tubing and embracing its proximal extremity. The purpose of this spacer fitting is twofold. When the spacer fitting is in the assembled position shown in FIG. 7, it prevents displacement of the multilumen tubing inside the insertion tube during attachment the connector means. When the spacer fitting is in the disassembled position shown in FIG. 10, it exposes a portion of the multilumen tubing for cutting and heat-sealing as will be apparent later on.

It should be appreciated that the multilumen tubing depicted in FIG. 6 consists of two lumens, the first of them being provided with one passage (for suction or for entering a surgical instrument therethrough) and the second one being provided with two passages (for air and for water). The multilumen tubing protrudes through the spacer fitting and outside the fitting there is seen proximal end 46 of the first lumen and proximal end 48 of the second lumen. It should be appreciated, however, that instead of two separate lumens the multilumen tubing could consist of a single integral body provided with three passages extending therealong. The further explanation of the present invention will be referring to integral multilumen tubing.

In FIG. 7 is seen how a cylindrical connector means 50 is attached to the proximal extremity of the multilumen tubing. This connector means functionally is similar to the connector 26 shown in FIG. 1. The connector means is in airtight communication with the multilumen tubing and with the tubes extending along the umbilical duct for connecting to the control unit. Furthermore the connector means is provided with a dedicated lateral port through which a surgical tool can be inserted in the multilumen tubing and evacuated therefrom. In FIG. I is shown connector 26 provided with a lateral port 48, while in FIG. 7 is shown connector means 46 provided with a lateral port 50.

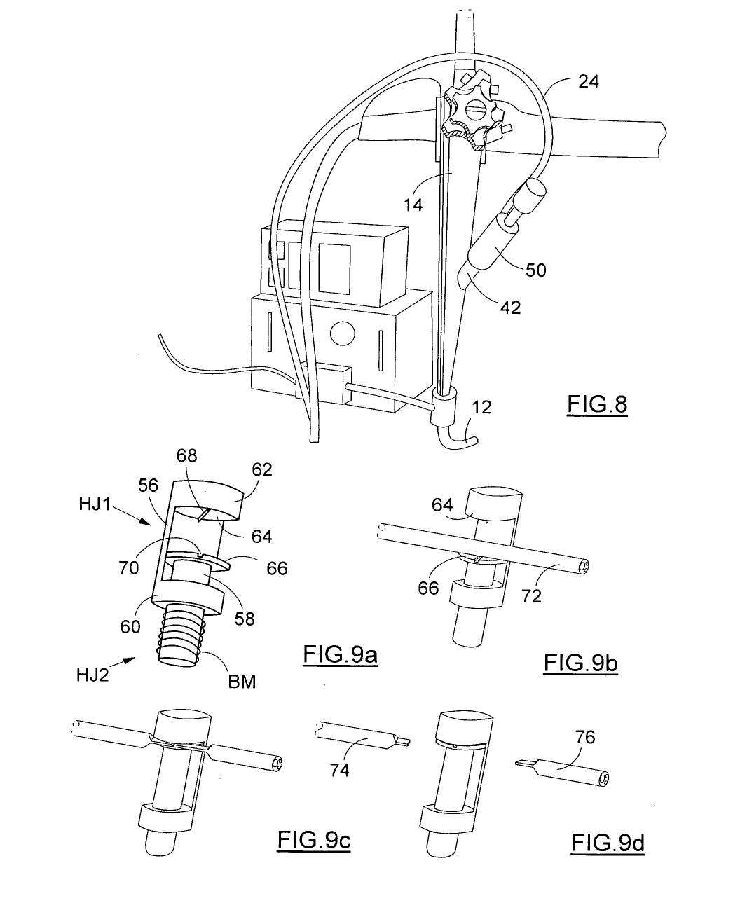

FIG. 1 and FIG. 8 depict the endoscopic apparatus being ready for commencing the endoscopic procedure. During this procedure the multilumen tubing may be contaminated since during the endoscopic procedure its distal end is in communication with the interior of a body passage. At the end of the endoscopic procedure the umbilical duct is disconnected from the connector means and the multilumen tubing is evacuated from the insertion tube. This operation might be associated with spreading the contamination from the multilumen tubing through its open proximal end. Cutting and heat-sealing of the proximal extremity in accordance with the present invention reliably prevents the spreading of contamination from the proximal end.

Referring to FIG. 9a it is shown schematically the principle, on which is based the method and device for cutting and sealing in accordance with the invention. The device comprises a first heating jaw HJ1 and a second heating jaw HJ2. The first heating jaw has a U-like end 56 and the second heating jaw has a bar-shaped end 58. The U-like end is fitted with a first leg 60 having an opening, through which the bar-shaped end of the second jaw can pass and there is provided a possibility for relative linear displacement between the heating jaws. In practice the U-like end of the first heating jaw is displaceable with respect to the bar-shaped end of the second heating jaw. It is not shown in FIG. 9, but should be appreciated that appropriate mechanism is provided for linear displacement of the first heating jaw. A second leg 62 of the U-like end is fitted with a flat surface 64 facing towards an opposite flat surface 66 arranged on the bar-shaped end 58 of the second heating jaw. Protruding from the surface 64 towards the surface 66 a cutting edge 68 is provided. A corresponding depression 70 is formed on the opposite surface 66.

It is shown schematically in FIG. 9a a biasing member BM, e.g. a coil spring. The biasing member urges the surface 64 of the first heating jaw to approach the surface 66 of the second heating jaw. In order to provide room between the surfaces one should overcome resistance of the biasing member and forcibly displace the first heating jaw so as to remove the surface 64 from the surface 66. This situation is shown in FIG. 9a. It should be also appreciated that surfaces 64, 66 are made of electrically conductive material (e.g. copper) and the surface 66 is electrically connected to a source of electrical power (not shown). Therefore when electric current is passed through the surface 66, it functions as an electrical resistance-heating element capable of transferring heat to any object which is brought in physical contact with it. In a situation when the surfaces approach each other the heat passes from the surface 66 to the surface 64 by conductivity.

In FIG. 9b is shown a situation when the first heating jaw is forcibly removed from the second heating jaw and a portion 72 of the multilumen tubing is placed between the surfaces 64 and 66. A biasing member (not shown) exerts pressure on the surface 64 and thus on the multilumen tubing. At the same time the surface 66 is heated by electrical power supplied thereto and heats the multilumen tubing. Since the multilumen tubing is made of a thermoplastic material it yields and squeezes due to simultaneous influence of pressure and heat. In practice the surface 66 is heated up to 230-250° C. The cutting edge 68 cuts the multilumen tubing and gradually approaches depression 70, while the flat surfaces 64, 66 deform the multilumen tubing as seen in FIG. 9c. When the portion 70 is finally cut the opposite ends 74, 76 thereof become heat-sealed as seen in FIG. 9d.

It can be readily appreciated that now, when the opposite ends 74,76 of the multilumen tubing are heat-sealed there is no possibility for the contamination accumulated during the endoscopic procedure to spread out from the proximal extremity of the multilumen tubing.

Referring now to FIG. 10 there is shown how cutting and heat-sealing is carried out in practice with the aim of the cutting and heat-sealing device corresponding to an embodiment shown in FIG. 11.

It is seen that spacer fitting 44 is opened to expose the portion 72 of the proximal extremity of the multilumen tubing. The portion 72 is placed between the opposite surfaces 64, 66 of the heating jaws and is cut and heat-sealed due to simultaneous applying of pressure and heat.

With reference to FIG. 11 it is shown an embodiment of the device suitable for simultaneous applying of pressure and heat to the multilumen tubing. The device is configured as a pistol having a handle 78, graspable by operator's hand and a working portion 80. The working portion comprises a first heating jaw 82 terminating by the U-like end 52 and a second heating jaw, which is embraced by the first jaw and which terminates by the bar-shaped end 58. The U-like end and the bar-shaped end are fitted with respective flat, opposite surfaces, which are seen in proximity to each other. It is not shown specifically but should be appreciated that the first heating jaw is linearly displaceable with respect to the second heating jaw and between the first jaw and the handle there is provided a biasing member forcing the first heating jaw to displace in a backward direction towards the second heating jaw. Pivotally connected to the handle 78 a trigger member 84 is provided, which upon pulling urges the first heating jaw against elastic force of the biasing member to be displaced in a forward direction so as to separate between the surfaces 64, 66. It is also seen an electrical cord 86, which electrically connects the device with a power supply source PSS for supplying electrical power required for the heating of the surface 66.

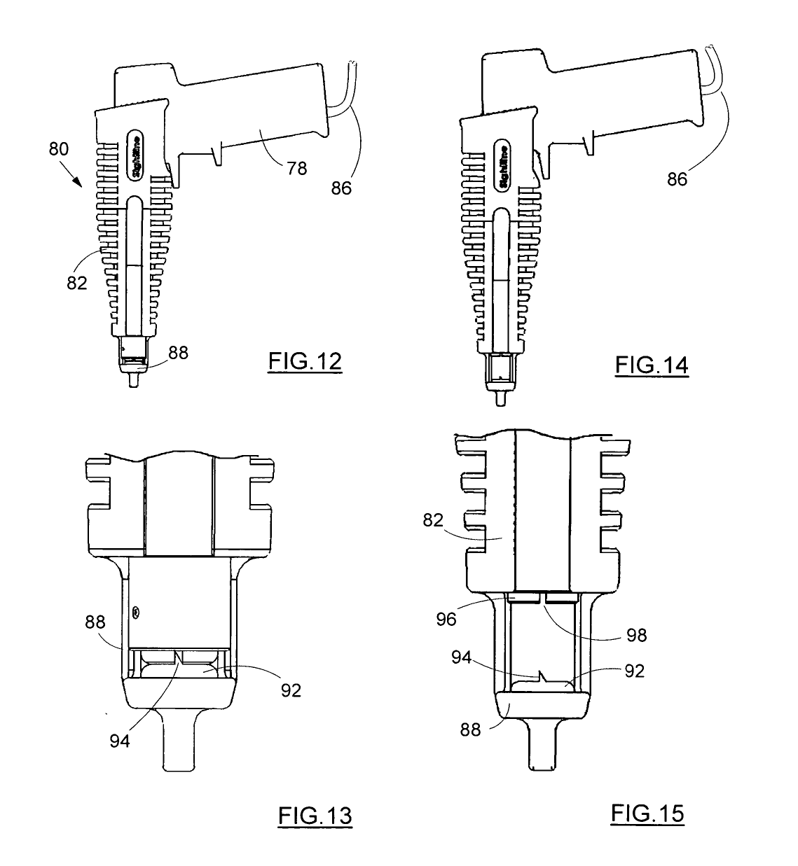

Referring now to FIGS. 12-16 still another embodiment of the device for cutting and heat-sealing will be described. In FIG. 12 is seen a general view of the device, which is, similarly to the previous embodiment, configured as a pistol, having a handle 78 carrying a working portion 80. The working portion comprises a first heating jaw 82 provided with a forward U-like end 88. Similarly to the previous embodiment the first heating jaw is linearly displaceable with respect to a second heating jaw and the second heating jaw terminates by a bar-shaped end 90.

FIG. 13 shows an enlarged view of the forward U-like end 88 of the first heating jaw. The second heating jaw is retained within the first jaw and is provided with a rear portion, which is connected to the handle. In this embodiment the device is not provided with a trigger member. In order to displace the first heating jaw in a forward direction and for separating the U-like end 88 from the bar-shaped end 90, a pushing force should be applied by the operator's hand immediate to a rear portion of the first heating jaw.

FIGS. 12 and 13 shows a situation where the U-like end of the first heating jaw approaches the bar-shaped end of the second heating jaw.

FIGS. 14 and 15 depict a situation when the first heating jaw has been pushingly displaced forward with respect to the second heating jaw.

As seen in FIGS. 12, 13, 14, and 15 the U-like end 88 of the first heating jaw is provided with a flat, metallic surface 92 fitted with a cutting edge 94, while the bar-shaped end 90 of the second heating jaw is provided with an opposite flat, metallic surface 96 formed with a protrusion 98. It is not shown but should be appreciated that the surface 96 is connected to a source of electrical current and can be heated when electrical current passes therethrough.

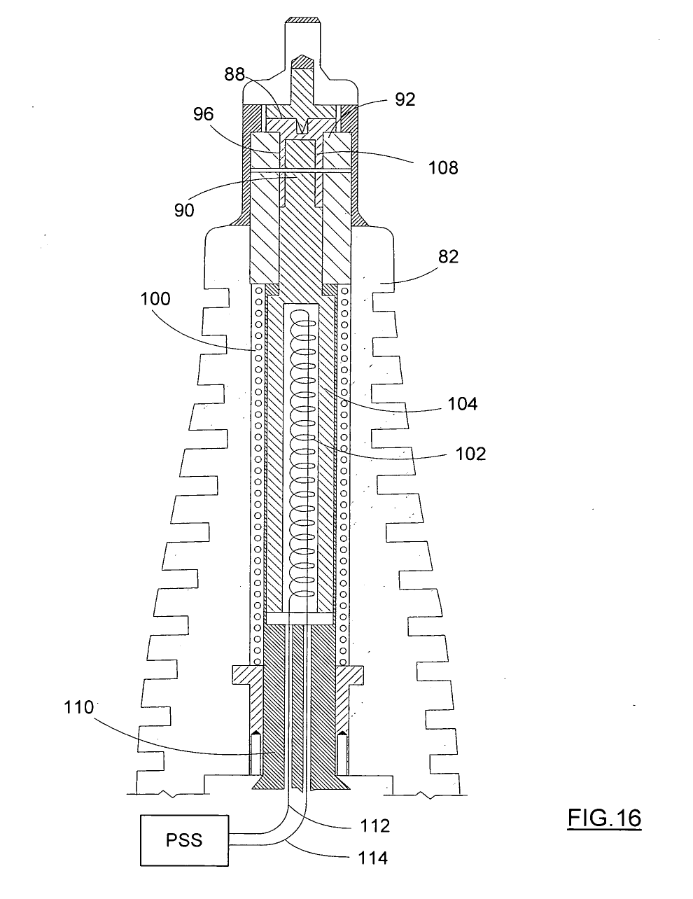

As seen in FIG. 16 a biasing member (spring) 100 is deployed within the first heating jaw. The spring is connected to the first jaw and to the second jaw in such a manner that it always pulls the first jaw in a backward direction to bring the surface 92 in rapprochement with the surface 96 as shown in FIGS. 12, 13, 16. To separate between the surfaces one should apply pushing force to the rear portion of the first heating jaw for displacing it in a forward direction. The situation when the first jaw has been pushed forward and the surfaces 92, 96 have been separated is shown in FIGS. 14, 15.

For linear displacement of the first heating jaw with respect to the second heating jaw appropriate guiding surfaces are made in the first and the second heating jaw.

For heating the surface 96 a heating element 102 configured as metallic spiral is used. The heating element is deployed within an intermediate elongated bushing 104. The bushing is made of material having high thermal conductivity. The bushing terminates by an extremity 106, on which tightly seats a tail portion 108 of the surface 96. Disposed within the first heating jaw an adapter 110 holds the bushing 104 in place. The ends of the spiral heating element are electrically connected to the power supply source PSS by wires 112,114 passing through the adapter and the handle.

It is advantageous if before commencing the cutting and sealing a thermal insulation layer, e.g. thing layer of Teflon is put on the portion of the multilumen tubing. The insulation layer prolongs the time during which the portion of the multilumen tubing is exposed to the simultaneous influence of heat and pressure, without however of premature collapsing. By virtue of this provision the cut ends of the multilumen tubing are reliably sterilized, while remaining intact and thus possibility for cross-contamination is avoided.

It should be appreciated that the above disclosed method and device for cutting and heat-sealing can be employed not only in connection with an endoscope, which is propelled by an inflatable sleeve. It can be used with any other endoscopes, in which it is required to prevent spreading of contamination from the multilumen tubing when it is evacuated from the endoscope.

It should be also appreciated that the invention is not limited to the above-described embodiments and that changes and one ordinarily skilled in the art can make modifications without deviation from the scope of the invention, as will be defined in the appended claims.

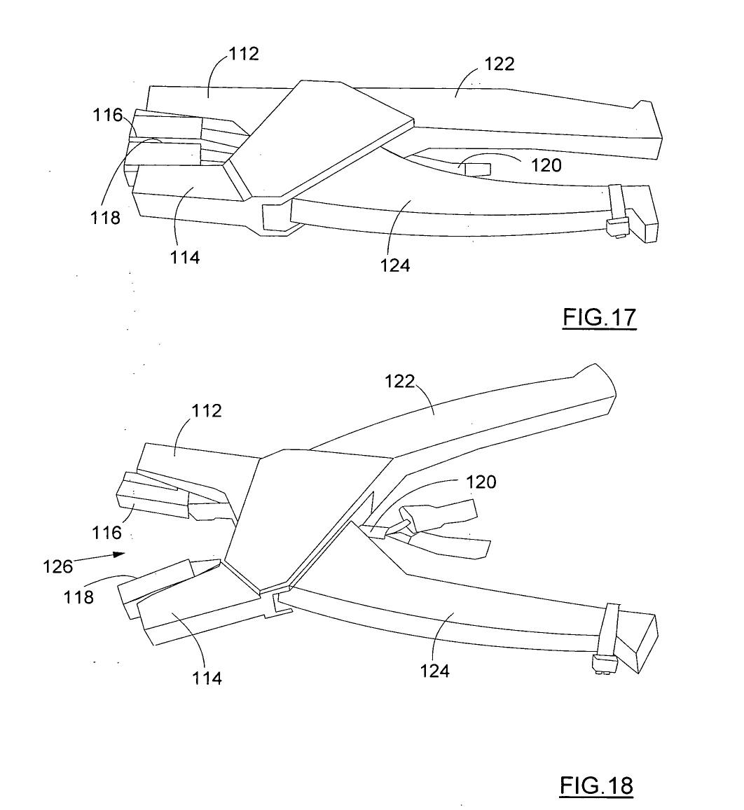

For example the device for cutting and heat-sealing could be configured not as a pistol, but as pliers. An example of such device is seen in FIGS. 17, 18. It is seen that in this embodiment two heating jaws 112, 114 are provided. The heating jaws are pivotally displaceable with respect to each other. The heating jaws are fitted with corresponding metallic surfaces 116,118. The heating jaws are always pressed to each other by a spring (not shown) provided in the pliers. An electrical cord 120 is provided for supplying electrical power required for heating of at least one of the surfaces 116,118. To separate the metallic surfaces one should pull handles 122,124 apart so as to pivotally displace the jaws as seen in FIG. 18. Then a portion of the multilumen tubing is placed in a free space 126 provided between the surfaces 116,118 and the handles are released. The biasing member brings the jaws in proximity to each other and the portion of the multilumen tubing placed in the space 126 is subjected to simultaneous influence of pressure and heat.

It should be born in mind also an embodiment, in which the biasing member always brings the jaws together when the handles are brought apart and in which for separating the surfaces 116,118 one should push on the handles 122,124 so as to bring them together instead of pulling them apart.

It should also be appreciated that the features disclosed in the foregoing description, and/or in the following claims, and/or in the accompanying drawings may, both separately and in any combination thereof, be material for realizing the present invention in diverse forms thereof.

When used in the following claims, the meaning of terms “comprise”, “include”, “have” and their conjugates is “including but not limited to”.

1. A method for cutting and sealing of a disposable multilumen tubing used with an endoscopic apparatus, said method comprising:
a) providing a first surface and a second surface positioned opposite said first surface,
b) placing a portion of the multilumen tubing between the first and the second surface,
c) applying heat and pressure to at least one of the first and the second surface so as to plastically deform and cut the said portion of the multilumen tubing and to heat-seal the cut ends thereof.

2. The method for cutting and sealing as defined in claim 1, in which said heat and pressure are applied simultaneously.

3. The method for cutting and sealing as defined in clam 2, comprising relative displacement of the first and the second surface before applying the heat and pressure to provide room for placement of the portion of the multilumen tubing between the first and the second surface.

4. The method for cutting and sealing as defined in claim 3, comprising displacement of the first surface with respect to the second surface.

5. The method for cutting and sealing as defined in claim], in which said pressure is applied by a biasing member.

6. The method for cutting and sealing as defined in claim 5, in which said pressure is applied to the first surface.

7. The method for cutting and sealing as defined in claim 1, comprising supplying of electrical power for heating of at least one of the first and the second surface.

8. The method for cutting and sealing as defined in claim 7, in which said electrical power is supplied to the second surface.

9. The method for cutting and sealing as defined in claim 1, in which said first and second surface are made of an electrically resistant material.

10. The method for cutting and sealing as defined in claim 1, in which said first and second surface are flat.

11. A device for cutting and sealing of a disposable multilumen tubing used with an endoscopic apparatus, said device comprising:
a) a first jaw and a second jaw juxtaposed to said first jaw, said first jaw and second jaw being relatively displaceable with respect to each other, said first and said second jaw being provided with respective first and second surfaces,
b) a biasing member bringing the first jaw in proximity with the second jaw and exerting pressure on at least one of the said first and the second surfaces,
c) a source of energy for heating of at least one of the said first and the second surface.

12. The device for cutting and sealing as defined in claim 11, wherein the first jaw is displaceable with respect to the second jaw.

13. The device for cutting and sealing as defined in claim 12, wherein said source of energy supplies electrical power to at least one of the first and second surface, wherein said first and second surface being made of electrically resistant material.

14. The device for cutting and sealing as defined in claim 13, wherein said device being configured as a pistol comprising a trigger member displacing the first jaw with respect to the second jaw.

15. The device for cutting and sealing as defined in claim 11, wherein said biasing member is a spring exerting pressure on the first surface to bring it together with the second surface.

16. The device for cutting and sealing as defined in claim 11, wherein said first jaw comprises a U-like forward end fitted with a first and a second leg, said second leg having an opening, and wherein said second jaw comprises a bar-shaped forward end extending through said opening.

17. The device for cutting and sealing as defined in claim 16, wherein said first surface being arranged on said first leg and said second surface being arranged on the bar-shaped end.

18. The device for cutting and sealing as defined in claim 17, wherein said first surface including a cutting edge and said second surface including a corresponding depression.

19. The device for cutting and sealing as defined in claim 13, wherein said electrical power is supplied to the second surface.

20. The device for cutting and sealing as defined in claim 13, wherein said device being configured as pliers.
